(19) United States
(12) Patent Application Publication
(10) Pub. No.: US 2024/0339777 A1
(43) Pub. Date: Oct. 10, 2024

(54) CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Shinji NOZAKI, Mie (JP); Daisuke SAITO, Mie (JP)

(21) Appl. No.: 18/294,388

(22) PCT Filed: Jun. 29, 2022
(86) PCT No.: PCT/JP2022/026061

§ 371 Date: Feb. 1, 2024

(30) Foreign Application Priority Data
Aug. 20, 2021 (JP) 2021-134733

(51) Int. Cl. H01R 13/424

(52) U.S. Cl. CPC H01R 13/424

(57) ABSTRACT

It is aimed to realize both an insertion resistance reduction and a holding force increase. A connector is provided with a connector housing configured by assembling a first housing and a second housing, a terminal fitting to be inserted into the connector housing, a resiliently deformable locking lance formed in the connector housing, and a resiliently undeformable complete locking portion formed in the connector housing. The both housings in an assembled state are displaceable to a primarily locked state where the complete locking portion is retracted to outside an insertion path for the terminal fitting and the terminal fitting is holdable in a retained state by the locking lance and a secondarily locked state where the locking lance is retracted to outside the insertion path for the terminal fitting and the terminal fitting is holdable in the retained state by the complete locking portion.

### TECHNICAL FIELD

The present disclosure relates to a connector.

### BACKGROUND

Patent Document 1 discloses a connector structured to retain a connection terminal inserted into a main housing. A locking arm formed in the main housing temporarily retains the connection terminal by locking the connection terminal. An auxiliary housing attached to the main housing is formed with a pressing portion. The pressing portion presses the locking arm, whereby the locking arm is held not to be disengaged from the connection terminal and the connection terminal is retained.

### PRIOR ART DOCUMENT

### Patent Document

Patent Document 1: JP 2001-244011 A

### SUMMARY OF THE INVENTION

### Problems to be Solved

If an attempt is made to reduce the size of the above connector, a holding force of the locking arm to retain the connection terminal is reduced since a locking margin of the connection terminal and the locking arm is reduced. If the locking margin of the locking arm and the connection terminal is increased to enhance the holding force, a resilient deformation amount of the locking arm, i.e. insertion resistance, increases in the process of inserting the connection terminal into the main housing.

A connector of the present disclosure was completed on the basis of the above situation and aims to realize both an insertion resistance reduction and a holding force increase.

### Means to Solve the Problem

The present disclosure is directed to a connector with a connector housing configured by assembling a first housing and a second housing, a terminal fitting to be inserted into the connector housing, a resiliently deformable locking lance formed in the connector housing and a resiliently undeformable complete locking portion formed in the connector housing, the first housing and the second housing in an assembled state being displaceable to a primarily locked state where the complete locking portion is retracted to outside an insertion path for the terminal fitting and the terminal fitting is holdable in a retained state by the locking lance and a secondarily locked state where the locking lance is retracted to outside the insertion path for the terminal fitting and the terminal fitting is holdable in the retained state by the complete locking portion.

### Effect of the Invention

According to the present disclosure, it is possible to realize both an insertion resistance reduction and a holding force increase.

### BRIEF DESCRIPTION OF THE DRAWINGS

FIG. 1 is a perspective view showing a state where a first housing and a second housing are assembled in a secondarily locked state in a connector of one embodiment.

FIG. 2 is a perspective view showing a state where the first housing and the second housing are assembled in a primarily locked state.

FIG. 3 is a side view in section showing the state where the first housing and the second housing are assembled in the secondarily locked state.

FIG. 4 is a side view in section showing the state where the first housing and the second housing are assembled in the primarily locked state.

FIG. 5 is a front view in section showing the state where the first housing and the second housing are assembled in the secondarily locked state.

FIG. 6 is a front view in section showing the state where the first housing and the second housing are assembled in the primarily locked state.

FIG. 7 is a perspective view partly in section of the first housing.

FIG. 8 is a perspective view of the second housing.

### DETAILED DESCRIPTION TO EXECUTE THE INVENTION

### Description of Embodiments of Present Disclosure

First, embodiments of the present disclosure are listed and described.

(1) The connector of the present disclosure is provided with a connector housing configured by assembling a first housing and a second housing, a terminal fitting to be inserted into the connector housing, a resiliently deformable locking lance formed in the connector housing and a resiliently undeformable complete locking portion formed in the connector housing, the first housing and the second housing in an assembled state being displaceable to a primarily locked state where the complete locking portion is retracted to outside an insertion path for the terminal fitting and the terminal fitting is holdable in a retained state by the locking lance and a secondarily locked state where the locking lance is retracted to outside the insertion path for the terminal fitting and the terminal fitting is holdable in the retained state by the complete locking portion.

According to this configuration, in inserting the terminal fitting into the connector housing, the first and second housings are assembled in the primarily locked state. In an insertion process of the terminal fitting, the locking lance interferes with the terminal fitting to be resiliently deformed, thereby generating insertion resistance. The terminal fitting is retained by the locking lance locking the terminal fitting. If the first and second housings are displaced to the secondarily locked state after the insertion of the terminal fitting, the terminal fitting is reliably retained by a high holding force by the resiliently undeformable complete locking portion. Since the terminal fitting can be reliably retained by the resiliently undeformable complete locking portion, a holding force by the locking lance may be small. Therefore, the terminal fitting can be retained by a high holding force while the insertion resistance due to the resilient deformation of the locking lance is reduced.

(2) Preferably, the locking lance and the complete locking portion are formed only in the first housing. According to this configuration, the shape of the second housing can be simplified.

(3) Preferably, the locking lance is formed in the first housing, a mold removal space formed by molding the locking lance is open in a front end surface of the first housing, the second housing is formed with a front wall portion for stopping in front the terminal fitting inserted into the connector housing, and the front wall portion is accommodated in the mold removal space with the first housing and the second housing assembled. If the front wall portion is formed in the first housing, the mold removal space is formed in the front wall portion and the shape of the first housing becomes complicated since a mold pin for molding the locking lance needs to be passed through the front wall portion. According to the above configuration, since the front wall portion is not formed with the mold removal space, the shape of the first housing can be simplified.

(4) Preferably, a plurality of the terminal fittings are arranged in parallel in a width direction in the connector housing, the first housing and the second housing are displaced to the primarily locked state and the secondarily locked state by being slid in the width direction, and the locking lances and the complete locking portions are alternately arranged in the width direction. According to this configuration, the locking lances and the complete locking portions can be molded by a mold, which is opened in a front-rear direction intersecting the width direction. Since a slide mold is not necessary, a mold structure can be simplified.

(5) Preferably, the connector housing includes a resiliently deformable locking arm for holding the first housing and the second housing in the assembled state, and the first housing is integrally formed with the locking lance and the locking arm. According to this configuration, materials of the first and second housings can be appropriately set according to whether or not resilient deformation is necessary, necessary rigidity and the like.

(6) Preferably, in (5), the first housing is integrally formed with a resiliently deformable lock arm for holding the connector housing and a mating connector in a connected state. According to this configuration, the materials of the first and second housings can be respectively appropriately set according to whether or not resilient deformation is necessary, necessary rigidity and the like.

(7) Preferably, the first housing is formed with an accommodation space for accommodating the second housing, a part of the second housing projects out from the accommodation space when the first housing and the second housing are in the primarily locked state, and the entire second housing is accommodated in the accommodation space when the first housing and the second housing are in the secondarily locked state. According to this configuration, in a state where the first and second housings are displaced to the secondarily locked state and the terminal fitting is reliably retained, no dead space is present in the accommodation space. Thus, useless enlargement of the connector housing can be avoided.

(8) Preferably, in (7), the first housing is formed with an opening for allowing the part of the second housing to project out from the first housing in the primarily locked state, and the second housing is formed with an expansion restricting portion for restricting the first housing from being deformed to expand the opening. According to this configuration, it is possible to prevent reductions in a retaining function by the locking lance and a retaining function by the complete locking portion due to the expansion of the opening of the accommodation space.

### Details of Embodiment of Present Disclosure

### Embodiment

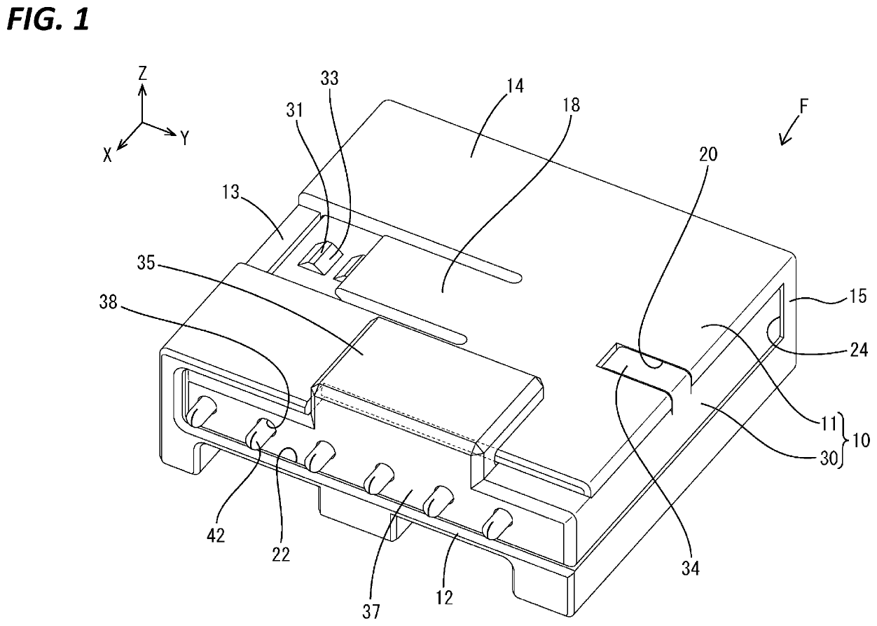

One specific embodiment of the present disclosure is described with reference to FIGS. 1 to 8. Note that the present invention is not limited to these illustrations, but is represented by claims and intended to include all changes in the scope of claims and in the meaning and scope of equivalents. In this embodiment, an X direction in FIGS. 1 to 4, 7 and 8 is defined as a forward direction concerning a front-rear direction. A Y direction in FIGS. 1, 2 and 5 to 8 is defined as a leftward direction concerning a lateral direction. The lateral direction and a width direction are used as synonyms. A Z direction in FIGS. 1 to 8 is defined as an upward direction concerning a vertical direction.

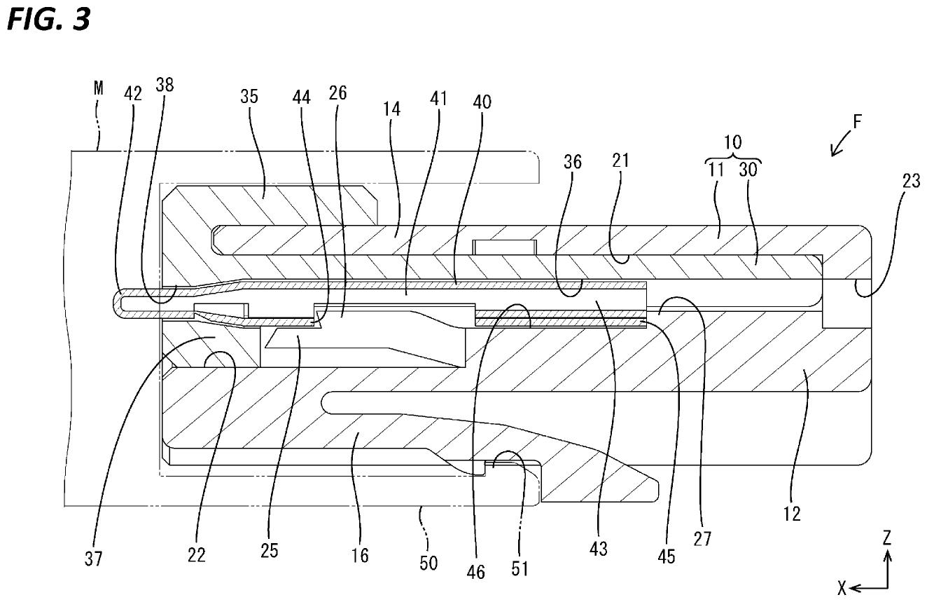

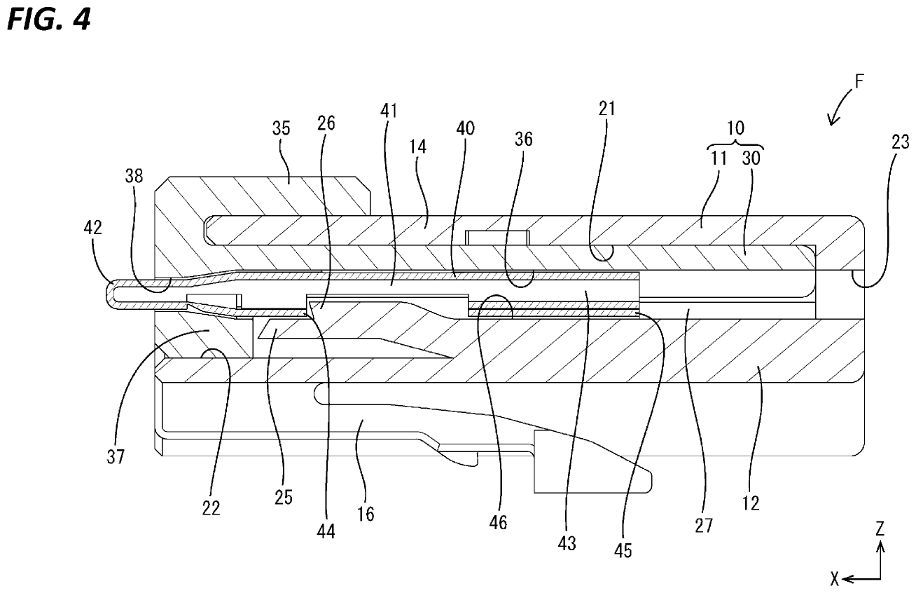

As shown in FIGS. 1 and 3, a connector F has a flat rectangular parallelepiped shape as a whole. As shown in FIG. 3, the connector F is fit into a receptacle 50 of a mating connector M. As shown in FIGS. 4 to 6, the connector F is configured by assembling one connector housing 10 and a plurality of terminal fittings 40. The connector housing 10 is configured by assembling a first housing 11, which is a single component made of synthetic resin, and a second housing 30, which is a single component made of synthetic resin.

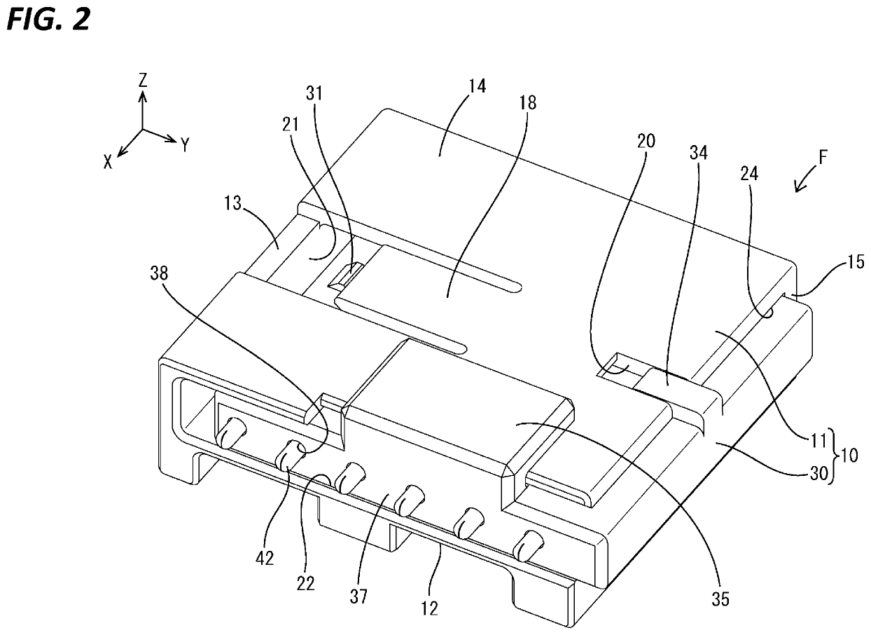

As shown in FIGS. 1 and 2, the first housing 11 includes a lower wall portion 12, a right wall portion 13, an upper wall portion 14 and a support column 15. The right wall portion 13 rises upward from the right end edge of the lower wall portion 12. The upper wall portion 14 extends leftward in parallel to the lower wall portion 12 from the upper end edge of the right wall portion 13, and is arranged to face the lower wall portion 12 while being spaced apart from the lower wall portion 12 in the vertical direction. The support column 15 is located on left rear end parts of the lower wall portion 12 and the upper wall portion 14 to keep a facing interval between the lower wall portion 12 and the upper wall portion 14 constant. The first housing 11 has a rectangular shape in a plan view.

A lock arm 16 for locking the connector F and the mating connector M in a connected state is integrally formed on the lower surface of the lower wall portion 12, i.e. on the outer surface of the first housing 11. In the process of connecting the connector F and the mating connector M, the lock arm 16 interferes with a lock portion 51 of the receptacle 50, thereby being resiliently deformed. When the connector F and the mating connector M reach a properly connected state, the lock arm 16 resiliently returns and is locked to the lock portion 15, whereby the connector F and the mating connector M are held in the connected state.

The upper wall portion 14 is formed with a locking arm 18 and a guide groove 20. The locking arm 18 is arranged at a center position in the front-rear direction of the upper wall portion 14. The locking arm 18 is a plate-like part continuous and flush with the upper surface of the upper wall portion 14 and cantilevered rightward. A locking protrusion 19 is formed on the lower surface of the locking arm 18. The locking arm 18 is resiliently displaceable upward. The guide groove 20 is formed by cutting a left end part of the upper wall portion 14. The guide groove 20 is elongated in the lateral direction and open in the upper and lower surfaces of the upper wall portion 14.

The inside of the first housing 11 functions as an accommodation space 21 for accommodating the second housing 30 and the plurality of terminal fittings 40. A mold removal space 22 is formed in a front end part of the first housing 11 as locking lances 25 to be described later are molded. The mold removal space 22 is a space constituting the accommodation space 21, and opens the accommodation space 21 in the front end surface of the first housing 11. A terminal insertion opening 23 opening the accommodation space 21 to a space outside and behind the first housing 11 is formed in the rear end surface of the first housing 11. An opening 24 for opening the accommodation space 21 to a space outside and lateral to the first housing 11 is formed in the left side surface of the first housing 11. A front end part of the opening 24 and a left end part of the mold removal space 22 communicate with each other. A rear end part of the opening 24 and a left end part of the terminal insertion opening 23 are partitioned by the support column 15.

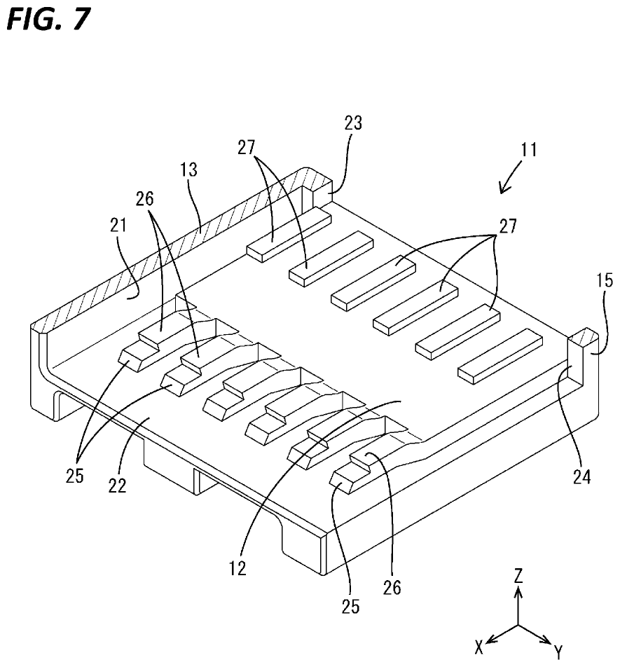

As shown in FIG. 7, the first housing 11 is integrally formed with a plurality of the locking lances 25 and a plurality of complete locking portions 27. The plurality of locking lances 25 are arranged in the accommodation space 21. Each locking lance 25 is supported on the upper surface of the lower wall portion 12 and has a cantilever shape extending forward. A retaining projection 26 is formed on the upper surface of each locking lance 25. Each locking lance 25 is resiliently deformable in the vertical direction with a rear end part of the locking lance 25 as a fulcrum. The plurality of locking lances 25 are located forward of a center in the front-rear direction of the first housing 11. The plurality of locking lances 25 are arranged in parallel at fixed intervals in the lateral direction.

The plurality of complete locking portions 27 are arranged in the accommodation space 21. Each complete locking portion 27 is shaped to project upward from the upper surface of the lower wall portion 12. The complete locking portion 27 has a rectangular shape elongated in the front-rear direction in a plan view. Each complete locking portion 27 is not resiliently deformed unlike the locking lance 25. The plurality of complete locking portions 27 are located behind the center in the front-rear direction of the first housing 11 in the front-rear direction. That is, the plurality of complete locking portions 27 are located behind the locking lances 25. The plurality of complete locking portions 27 are arranged in parallel at fixed intervals in the lateral direction. An arrangement interval of the complete locking portions 27 is equal to that of the locking lances 25.

The number of the locking lances 25 and that of the complete locking portions 27 are equal. The plurality of locking lances 25 and the plurality of complete locking portions 27 are arranged in a staggered manner in a plan view. That is, the complete locking portions 27 are located obliquely to the right of and behind the locking lances 25. In the lateral direction, the complete locking portions 27 are arranged between adjacent ones of the locking lances 25.

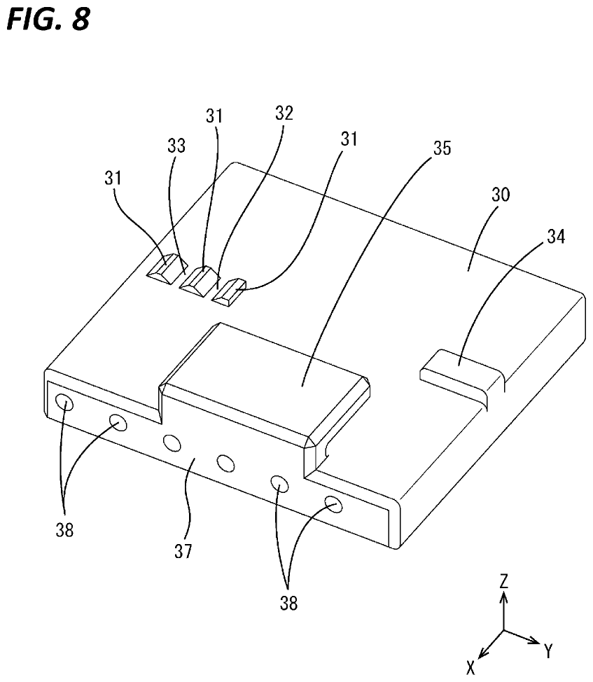

As shown in FIG. 8, the second housing 30 has a flat rectangular parallelepiped shape rectangular in a plan view. Three holding projections 31 arranged in the lateral direction are formed on the upper surface of the second housing 30. The holding projections 31 are arranged in a central part of the second housing 30 in the front-rear direction. In the lateral direction, the holding projections 31 are arranged in a right end part of the second housing 30. A primary lock holding portion 32 is constituted by the right holding projection 31 and the middle holding projection 31, out of the three holding projections 31. A secondary lock holding portion 33 is constituted by the middle holding projection 31 and the left holding projection 31.

A guide rib 34 is formed on the upper surface of the second housing 30. The guide rib 34 is arranged in the central part of the second housing 30 in the front-rear direction. In the lateral direction, the guide rib 34 is arranged in a left end part. The guide rib 34 has a rectangular shape elongated in the lateral direction in a plan view. An expansion restricting portion 35 is formed on the upper surface of the second housing 30. The expansion restricting portion 35 is shaped to rise from the front end edge of the second housing 30 and extend rearward in a plate-like manner.

As shown in FIGS. 3 to 6, a plurality of terminal holding grooves 36 elongated in the front-rear direction are formed at fixed intervals in the lateral direction in the lower surface of the second housing 30. The arrangement interval of the terminal holding grooves 36 is equal to those of the locking lances 25 and the complete locking portions 27. The rear ends of the terminal holding grooves 36 are open rearward. A front end part of the second housing 30 is formed with a front wall portion 37. The front ends of the terminal holding grooves 36 are partitioned from a space outside and in front of the second housing 30 by the front wall portion 37 constituting the front end surface of the second housing 30. The front wall portion 37 is formed with a plurality of terminal through holes 38 penetrating through the front wall portion 37 in the front-rear direction and arranged at fixed intervals in the lateral direction. The plurality of terminal through holes 38 individually communicate with the plurality of terminal holding grooves 36.

As shown in FIGS. 3 and 4, the terminal fitting 40 is a component having a shape elongated in the front-rear direction as a whole. A tubular terminal body portion 41 is formed in a central part in the front-rear direction of the terminal fitting 40. A front end part of the terminal fitting 40 is formed with a cylindrical connecting portion 42 elongated forward from the front end of the terminal body portion 41. A tubular wire fixing portion 43 extending rearward from the rear end of the terminal body portion 41 is formed in a rear end part of the terminal fitting 40. A front end of a wire (not shown) is conductively fixed to the wire fixing portion 43. The terminal fitting 40 is formed with a primary locking portion 44 by cutting a lower surface part of the terminal body portion 41. The lower surface part at the rear end of the wire fixing portion 43 functions as a secondary locking portion 45.

Next, an assembly process of the connector F is described. First, the second housing 30 is mounted into the accommodation space 21 of the first housing 11. At this time, the right end part of the second housing 30 is inserted into the opening 24 from the left of the first housing 11, and the rear surface of the second housing 30 is brought into contact with the front surface of the support column 15, whereby the both housings 11, 30 are positioned in the front-rear direction. If the second housing 30 is relatively displaced rightward, i.e. in the width direction of the connector housing 10, with respect to the first housing 11 in this state, the second housing 30 is inserted into the accommodation space 21. In an insertion process of the second housing 30, the upper wall portion 14 of the first housing 11 enters between the upper surface of the second housing 30 and the expansion restricting portion 35. As the second housing 30 is further inserted into the accommodation space 21, the guide rib 34 is fit into the guide groove 20, whereby the second housing 30 is guided with respect to the first housing 11.

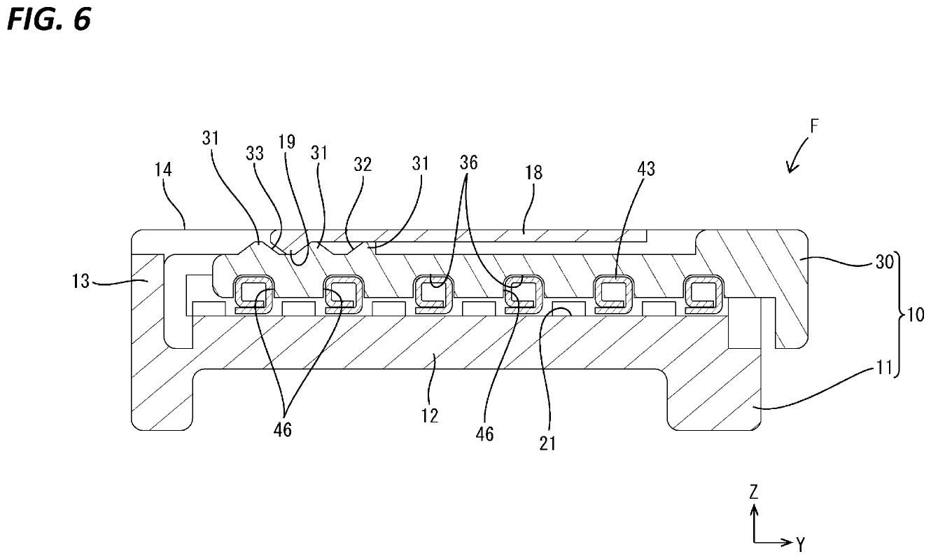

When the first and second housings 11, 30 are primarily locked as shown in FIG. 2, the locking protrusion 19 of the locking arm 18 is locked to the primary lock holding portion 32 as shown in FIG. 6, whereby the both housings 11, 30 are held in a primarily locked state. In the primarily locked state, the terminal holding grooves 36 (insertion paths for the terminal fittings 40) are arranged at the same positions as the locking lances 25 in the lateral direction. The complete locking portions 27 are arranged at positions deviated from the terminal holding grooves 36 in the lateral direction. The front wall portion 37 of the second housing 30 is accommodated into the mold removal space 22 of the first housing 11 and exposed in the front surface of the first housing 11. The rear surface of the second housing 30 is exposed in the rear surface of the first housing 11 in the terminal insertion opening 23 of the first housing 11. A left edge part of the second housing 30 projects to the left of the first housing 11 from the opening 24. A plurality of terminal accommodation chambers 46 are formed by the terminal holding grooves 36 of the second housing 30 and the upper surface of the lower wall portion 12 of the first housing 11 inside the connector housing 10.

With the both housings 11, 30 held in the primarily locked state, the terminal fitting 40 is inserted into the terminal holding groove 36 (terminal accommodation chamber 46) from behind the connector housing 10. In an insertion process of the terminal fitting 40, the terminal body portion 41 interferes with the retaining projection 26 of the locking lance 25, whereby the locking lance 25 is resiliently deformed downward. When the terminal fitting 40 reaches a proper insertion position, the front end of the terminal body portion 41 comes into contact with the front wall portion 37, whereby the terminal fitting 40 is held in a front stop state. The connecting portion 42 projects forward of the second housing 30 through the terminal through hole 38.

When the terminal fitting 40 reaches the proper insertion position, the locking lance 25 resiliently returns upward and the retaining projection 26 is lockable to the primary locking portion 44 of the terminal fitting 40 from behind as shown in FIG. 4. In this way, the terminal fitting 40 is held in a state where rearward separation is restricted. This retention by the locking lance 25 is a function as temporary holding until all the terminal fittings 40 are inserted into the terminal holding grooves 36. A holding force by the locking lance 25 may be a minimum necessary force to retain the terminal fitting 40 when a small rearward pulling force is applied to the terminal fitting 40. Therefore, a locking margin in the vertical direction between the retaining projection 26 and the primary locking portion 44 is relatively small and a resilient deformation amount of the locking lance 25 in the insertion process of the terminal fitting 40 is also suppressed to be small.

After all the terminal fittings 40 are inserted into the terminal holding grooves 36 and retained in a temporarily held state by the primary locking action of the locking lances 25, the second housing 30 is moved rightward with respect to the first housing 11. At this time, the locking arm 18 is resiliently deformed upward, whereby the locking protrusion 19 is disengaged from the primary lock holding portion 32.

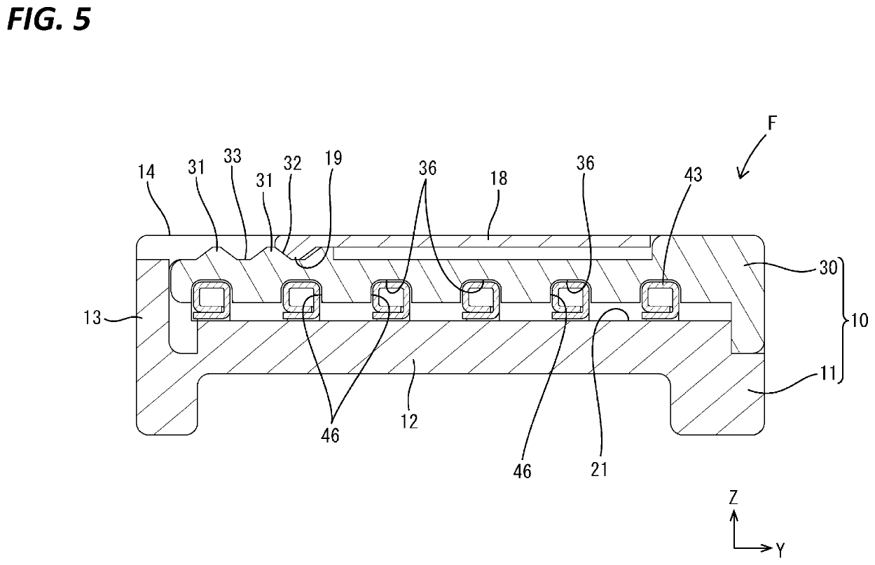

When the first and second housings 11, 30 are secondarily locked as shown in FIG. 1, the locking arm 18 resiliently returns and the locking protrusion 19 is locked to the secondary lock holding portion 33 as shown in FIG. 5. By this locking action, the both housings 11, 30 are held in a secondarily locked state. The front wall portion 37 of the second housing 30 is accommodated in the mold removal space 22 of the first housing 11 and held in a state exposed in the front surface of the first housing 11. The rear surface of the second housing 30 is kept exposed in the rear surface of the first housing 11 in the terminal insertion opening 23 of the first housing 11. The entire second housing 30 is accommodated into the accommodation space 21, and the left edge part of the second housing 30 does not project to the left of the first housing 11. The left outer side surface of the second housing 30 is exposed in the outer surface of the first housing 11 in the opening 24.

Even if the both housings 11, 30 are displaced from the primarily locked state to the secondarily locked state, a state where the plurality of terminal accommodation chambers 46 are formed by the terminal holding grooves 36 and the lower wall portion 12 of the first housing 11 and a state where the terminal fittings 40 are inserted in the terminal accommodation chambers 46 are maintained inside the connector housing 10. The locking lances 25 are displaced to positions deviated from the terminal holding grooves 36 in the lateral direction.

The complete locking portions 27 are arranged at the same positions as the terminal holding grooves 36 (terminal accommodation chambers 46) and the terminal fittings 40 in the lateral direction. The complete locking portions 27 are in a state lockable to the secondarily locking portions 45 of the terminal fittings 40 from behind. In this way, the terminal fittings 40 are held in the state where rearward separation is restricted. The complete locking portions 27 are integrally formed to the first housing 11 so as not be resiliently deformed. A retaining function by the complete locking portion 27 exhibits a large holding force capable of reliably retaining the terminal fitting 40 even if the terminal fitting 40 is pulled rearward with a strong force.

The connector F of this embodiment includes the connector housing 10 and the plurality of terminal fittings 40 to be inserted into the connector housing 10. The connector housing 10 is configured by assembling the first and second housings 11, 30. The connector housing 10 is formed with the resiliently deformable locking lances 25. The connector housing 10 is formed with the resiliently undeformable complete locking portions 27. The first and second housings 11, 30 in the assembled state can be selectively displaced to the primarily locked state and the secondarily locked state. In the primarily locked state, the complete locking portions 27 are retracted to outside the insertion paths for the terminal fitting 40 (to positions deviated from the terminal holding grooves 36) and the terminal fittings 40 can be held retained by the locking lances 25. In the secondarily locked state, the locking lances 25 are retracted to outside the insertion paths for the terminal fitting 40 (to positions deviated from the terminal holding grooves 36) and the terminal fittings 40 can be held retained by the complete locking portions 27.

According to this configuration, in inserting the terminal fitting 40 into the connector housing 10, the first and second housings 11, 30 are assembled in the primarily locked state. In the insertion process of the terminal fitting 40, the locking lance 25 interferes with the terminal fitting 40 to be resiliently deformed, thereby generating insertion resistance. The terminal fitting 40 is retained by the locking lance 25 locking the terminal fitting 40. If the first and second housings 11, 30 are displaced to the secondarily locked state after the insertion of the terminal fittings 40, the terminal fittings 40 are reliably retained by high holding forces by the resiliently undeformable complete locking portions 27. Since the terminal fittings 40 can be reliably retained by the resiliently undeformable complete locking portions 27, holding forces by the locking lances 25 may be small. Therefore, the terminal fittings 40 can be retained by high holding forces while the insertion resistance due to the resilient deformation of the locking lances 25 is reduced.

The locking lances 25 are formed in the first housing 11, and the mold removal space 22 formed by the molding of the locking lances 25 is open in the front end surface of the first housing 11. The second housing 30 is formed with the front wall portion 37 for stopping in front the terminal fittings 40 inserted into the connector housing 10. With the first and second housings 11, 30 assembled, the front wall portion 37 is accommodated in the mold removal space 22. If the front wall portion 37 is formed in the first housing 11, the mold removal space 22 is formed in the front wall portion 37 and the shape of the first housing 11 becomes complicated since mold pins for molding the locking lances 25 need to be passed through the front wall portion 37. However, since the front wall portion 37 is not formed with the mold removal space 22 according to the configuration of this embodiment, the shape of the first housing 11 can be simplified. Since the locking lances 25 and the complete locking portions 27 are formed only in the first housing 11, the shape of the second housing 30 can be simplified.

The plurality of terminal fittings 40 are arranged in parallel in the width direction in the connector housing 10. The first and second housings 11, 30 can be displaced alternately to the primarily locked state and the secondarily locked state by being slid in the width direction. The plurality of locking lances 25 and the plurality of complete locking portions 27 are alternately arranged in the width direction. According to this configuration, the locking lances 25 and the complete locking portions 27 can be molded by a mold, which is opened in the front-rear direction intersecting the width direction. Since a slide mode is not necessary, a mold structure can be simplified.

The connector housing 10 includes the resiliently deformable locking arm 18 for holding the first and second housings 11, 30 in the assembled state. The first housing 11 is integrally formed with the locking lances 25 and the locking arm 18. According to this configuration, materials of the first and second housings 11, 30 can be appropriately set according to whether or not resilient deformation is necessary, necessary rigidity and the like. The first housing 11 is integrally formed with the resiliently deformable lock arm 16 for holding the connector housing 10 and the mating connector M in the connected state. According to this configuration, the materials of the first and second housings 11, 30 can be respectively appropriately set according to whether or not resilient deformation is necessary, necessary rigidity and the like.

The first housing 11 is formed with the accommodation space 21 for accommodating the second housing 30. When the first and second housings 11, 30 are in the primarily locked state, the left edge part of the second housing 30 projects out from the accommodation space 21. When the first and second housings 11, 30 are in the secondarily locked state, the entire second housing 30 is accommodated in the accommodation space 21. According to this configuration, in a state where the first and second housings 11, 30 are displaced to the secondarily locked state and the terminal fittings 40 are reliably retained, no dead space is present in the accommodation space 21. Thus, useless enlargement of the connector housing 10 can be avoided.

The first housing 11 is formed with the opening 24 for allowing the left edge part of the second housing 30 to project out from the first housing 11 in the primarily locked state. The second housing 30 is formed with the expansion restricting portion 35 for restricting the upper wall portion 14 of the first housing 11 from being deformed to expand the opening 24. According to this configuration, it is possible to prevent reductions in the retaining function by the locking lances 25 and the retaining function by the complete locking portions 27 due to the expansion of the opening 24 of the accommodation space 21.

### OTHER EMBODIMENTS

The present invention is not limited to the above described and illustrated embodiment, but is represented by claims. The present invention is intended to include all changes in the scope of claims and in the meaning and scope of equivalents and also include the following embodiments.

Either the locking lances or the complete locking portions may be formed in the first housing, the others may be formed in the second housing.

The front wall portion for stopping the terminal fittings in front may be formed in the first housing (housing formed with the locking lances).

A parallel direction of the plurality of terminal fittings and a displacement direction of the first and second housings may be different. Specifically, the terminal fittings may be arranged in parallel in the width direction, and the first and second housings may be displaced in the vertical direction.

The first housing may be formed with the locking lances and the second housing may be formed with the locking arm and the lock arm, or the first housing may be formed with the locking lances and the locking arm and the second housing may be formed with the lock arm, or the first housing may be formed with the locking lances and the lock arm and the second housing may be formed with the locking arm.

The accommodation space may be sized to accommodate the entire second housing in the primarily locked state.

The accommodation space may be shaped not to include the opening for allowing a part of the second housing to project out from the first housing.

### LIST OF REFERENCE NUMERALS

F . . . connector
M . . . mating connector
10 . . . connector housing
11 . . . first housing
12 . . . lower wall portion
13 . . . right wall portion
14 . . . upper wall portion
15 . . . support column
16 . . . lock arm
18 . . . locking arm
19 . . . locking protrusion
20 . . . guide groove
21 . . . accommodation space
22 . . . mold removal space
23 . . . terminal insertion opening
24 . . . opening
25 . . . locking lance
26 . . . retaining projection
27 . . . complete locking portion
30 . . . second housing
31 . . . holding projection
32 . . . primary lock holding portion
33 . . . secondary lock holding portion
34 . . . guide rib
35 . . . expansion restricting portion
36 . . . terminal holding groove
37 . . . front wall portion
38 . . . terminal through hole
40 . . . terminal fitting
41 . . . terminal body portion
42 . . . connecting portion
43 . . . wire fixing portion
44 . . . primary locking portion
45 . . . secondary locking portion
46 . . . terminal accommodation chamber
50 . . . receptacle
51 . . . lock portion

1. A connector, comprising:
a connector housing configured by assembling a first housing and a second housing;
a terminal fitting to be inserted into the connector housing;
a resiliently deformable locking lance formed in the connector housing; and
a resiliently undeformable complete locking portion formed in the connector housing,
the first housing and the second housing in an assembled state being displaceable to:
a primarily locked state where the complete locking portion is retracted to outside an insertion path for the terminal fitting and the terminal fitting is holdable in a retained state by the locking lance; and
a secondarily locked state where the locking lance is retracted to outside the insertion path for the terminal fitting and the terminal fitting is holdable in the retained state by the complete locking portion.

2. The connector of claim 1, wherein the locking lance and the complete locking portion are formed only in the first housing.

3. The connector of claim 1, wherein:
the locking lance is formed in the first housing,
a mold removal space formed by molding the locking lance is open in a front end surface of the first housing,
the second housing is formed with a front wall portion for stopping in front the terminal fitting inserted into the connector housing, and
the front wall portion is accommodated in the mold removal space with the first housing and the second housing assembled.

4. The connector of claim 1, wherein:
a plurality of the terminal fittings are arranged in parallel in a width direction in the connector housing,
the first housing and the second housing are displaced to the primarily locked state and the secondarily locked state by being slid in the width direction, and
the locking lances and the complete locking portions are alternately arranged in the width direction.

5. The connector of claim 1, wherein:
the connector housing includes a resiliently deformable locking arm for holding the first housing and the second housing in the assembled state, and
the first housing is integrally formed with the locking lance and the locking arm.

6. The connector of claim 5, wherein the first housing is integrally formed with a resiliently deformable lock arm for holding the connector housing and a mating connector in a connected state.

7. The connector of claim 1, wherein:
the first housing is formed with an accommodation space for accommodating the second housing,
a part of the second housing projects out from the accommodation space when the first housing and the second housing are in the primarily locked state, and
the entire second housing is accommodated in the accommodation space when the first housing and the second housing are in the secondarily locked state.

8. The connector of claim 7, wherein:
the first housing is formed with an opening for allowing the part of the second housing to project out from the first housing in the primarily locked state, and
the second housing is formed with an expansion restricting portion for restricting the first housing from being deformed to expand the opening.
